(19) United States
(12) Patent Application Publication
(10) Pub. No.: US 2019/0341025 A1
(43) Pub. Date: Nov. 7, 2019

(54) INTEGRATED UNDERSTANDING OF USER CHARACTERISTICS BY MULTIMODAL PROCESSING

(71) Applicant: Sony Interactive Entertainment Inc., Tokyo (JP)

(72) Inventors: Masanori Omote, Half Moon Bay, CA (US); Ruxin Chen, Foster City, CA (US); Xavier Menendez-Pidal, Campbell, CA (US); Jaekwon Yoo, Foster City, CA (US); Koji Tashiro, Kanagawa (JP); Sudha Krishnamurthy, Foster City, CA (US); Komath Naveen Kumar, San Mateo, CA (US)

(21) Appl. No.: 16/383,896

(22) Filed: Apr. 15, 2019

Related U.S. Application Data
(60) Provisional application No. 62/659,657, filed on Apr. 18, 2018.

(51) Int. Cl. G10L 15/16; G10L 15/26

(52) U.S. Cl. CPC G10L 15/16; G10L 15/26

(57) ABSTRACT

A system and method for multimodal classification of user characteristics is described. The method comprises receiving audio and other inputs, extracting fundamental frequency information from the audio input, extracting other feature information from the video input, classifying the fundamental frequency information, textual information and video feature information using the multimodal neural network.

### CLAIM OF PRIORITY

This application claims the priority benefit of U.S. Provisional Patent Application No. 62/659,657, filed Apr. 18, 2019, the entire contents of which are incorporated herein by reference.

### FIELD OF THE INVENTION

This application relates to a multimodal system for modeling user behavior, more specifically the current application relates to understanding user characteristics using a neural network with multimodal inputs.

### BACKGROUND OF THE INVENTION

Currently computer systems have separate systems for facial recognition, and speech recognition. These separate systems work independently of each other and provide separate output information which is used independently.

For emotion recognition and modeling of user characteristics simply using one system may not provide enough contextual information to accurately model the emotions or behavior characteristics of the user.

Thus, there is a need in the art, for a system that can utilize multiple modes of input to determine user emotion and/or behavior characteristics.

### BRIEF DESCRIPTION OF THE DRAWINGS

The teachings of the present invention can be readily understood by considering the following detailed description in conjunction with the accompanying drawings, in which:

FIG. 1A is a schematic diagram of a sentence level multimodal processing system implementing feature level fusion according to aspects of the present disclosure.

FIG. 1B is a schematic diagram of a word or viseme level multimodal processing system implementing feature level fusion according to aspects of the present disclosure.

FIG. 2 is a block diagram of a method for multimodal processing with feature level fusion according to aspects of the present disclosure.

FIG. 3A is a schematic diagram of a multimodal processing system implementing enhanced sentence length feature level fusion according to aspects of the present disclosure.

FIG. 3B is a schematic diagram of a multimodal processing system implementing another enhanced sentence level feature level fusion according to aspects of the present disclosure.

FIG. 4 is a schematic diagram of a multimodal processing system implementing decision fusion according to aspects of the present disclosure.

FIG. 5 is a block diagram of a method for multimodal processing with decision level fusion according to aspects of the present disclosure.

FIG. 6 is a schematic diagram of a multimodal processing system implementing enhanced decision fusion according to aspects of the present disclosure.

FIG. 7 is a schematic diagram of a multimodal processing system for classification of user characteristics according to an aspect of the present disclosure.

FIG. 8A is a line graph diagram of an audio signal for rule based acoustic feature extraction according to an aspect of the present disclosure.

FIG. 8B is a line graph diagram showing the Fundamental frequency determination functions according to aspects of the present disclosure.

FIG. 9A is a flow diagram illustrating a method for recognition using auditory attention cues according to an aspect of the present disclosure.

FIGS. 9B-9F are schematic diagrams illustrating examples of spectro-temporal receptive filters that can be used in aspects of the present disclosure.

FIG. 10A is a simplified node diagram of a recurrent neural network for according to aspects of the present disclosure.

FIG. 10B is a simplified node diagram of an unfolded recurrent neural network for according to aspects of the present disclosure.

FIG. 10C is a simplified diagram of a convolutional neural network for according to aspects of the present disclosure.

FIG. 10D is a block diagram of a method for training a neural network that is part of the multimodal processing according to aspects of the present disclosure.

FIG. 11 is a block diagram of a system implementing training and method for multimodal processing according to aspects of the present disclosure.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

Multimodal Processing System

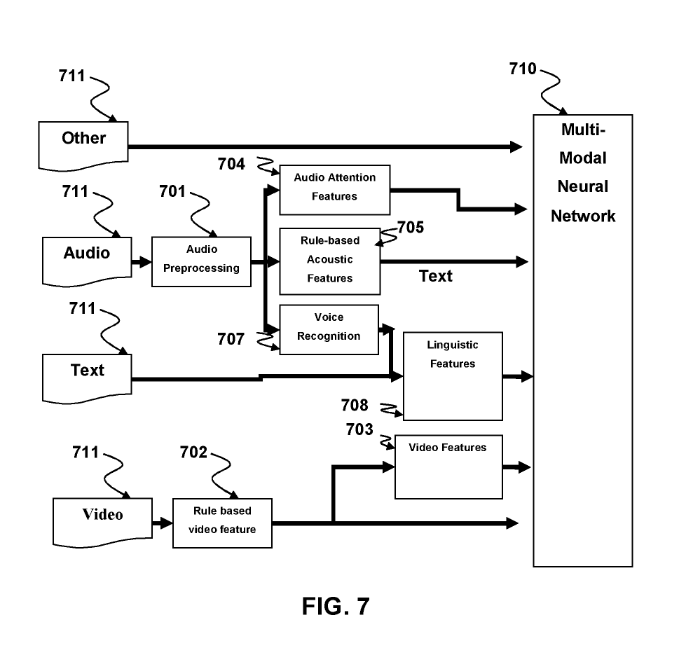

FIG. 7 shows a multimodal processing system according to aspects of the present disclosure. The described system classifies multiple different types of input 711 hereinafter referred to as multimodal processing to provide an enhanced understanding of user characteristics. The Multimodal processing system may receive inputs 711 that undergo several different types of processing 701, 702 and analysis 704, 705, 707, 708, to generate feature vector embedding for further classification by a multimodal neural network 710 configured to provide an output of classifications of user characteristics and distinguish between multiple users having separate characteristics. User characteristics as used herein may describe one or more different aspects of the user's current state including the emotional state of the user, the intentions of the user, the internal state of the user, the personality of the user, the identity of the user, and the mood of the user. The emotional state as used herein is a classification of the emotion the user currently experiences by way of example and not by way of limitation. The emotional state of the user may be described using adjectives, such as happy, sad, angry, etc. The intentions of the user as used herein is a classification of what the user is planning next within the context of the environment. The internal state of the user as used herein is the classification of the user's current physical state and/or mental state corresponding to an internal feeling, for example whether they are attentive, interested, uninterested, tired etc. Personality as used herein is the classification of the user's personality corresponding to a likelihood that the user will react in a certain way to a stimulus. The user's personality may be defined without limitation using five or more different traits. Those traits may be Openness to experience, Conscientiousness, Extroversion, Agreeableness, and Neuroticism. The Identity of the user as used herein corresponds to user recognition, but may also include recognition that user is behaving incongruently with other previously identified user characteristics. The mood of the user herein refers to the classification of the user's continued emotional state over a period of time, for example, a user who is classified as angry for an extended period may further be classified as being in a bad mood or angry mood. The period of time for mood classification is longer than emotional classification but shorter than personality classification. Using these user characteristics a system integrated with the multimodal processing system may gain a comprehensive understanding of the user.

The Multimodal Processing system according to aspects of the present disclosure may provide enhanced classification of targeted features as compared to separate single modality recognition systems. The multimodal processing system may take any number of different types of inputs and combine them to generate a classifier. By way of example and not by way of limitation the multimodal processing system may classify user characteristics from audio and video or video and text or text and audio, or text and audio and video or audio, text, video and other input types. Other types of input may include but is not limited to such data as heartbeat, galvanic skin response respiratory rate and other biological sensory input. According to alternative aspects of the present disclosure the multimodal processing system may take different types of feature vectors, combine them and generate a classifier.

By way of example and not by way of limitation the multimodal processing system may generate a classifier for a combination of rule based acoustic features 705 and audio attention features 704, or rule based acoustic features 705 and linguistic features 708, or linguistic features 708 and audio attention features 704, or rule based video features 702 and neural video features 703, or rule-based acoustic features 705 and rule-based video features 702, rule based acoustic features 705, or any combination thereof. It should be noted that the present disclosure is not limited to a combination of two different types of features and the presently disclosed system may generate a classifier for any number of different feature types generated from the same source and/or different sources. According to alternative aspects of the present disclosure the multimodal processing system may comprise numerous analysis and feature generating operations, the results of which are provided to the multimodal neural network. Such operations are without limitation; performing audio pre-processing on input audio 701, generating audio attention features from the processed audio 704, generating rule-based audio features from the processed audio 705, performing voice recognition on the audio to generate a text representation of the audio 707, performing natural language understanding analysis on text 709, performing linguistic feature analysis on text 708, generating rule-based video features from video input 702, generating deep learned video embeddings from rule based video features 703 and generating additional features for other types of input such as haptic or tactile inputs.

Multimodal Processing as described herein includes at least two different types of multimodal processing referred to as Feature Fusion processing and Decision Fusion processing. It should be understood that these two types of processing methods are not mutually exclusive and the system may choose the type of processing method that is used, before processing or switch between types during processing.

Feature Fusion

Feature fusion according to aspects of the present disclosure, takes feature vectors generated from input modalities and fuses them before sending the fused feature vectors to a classifier neural network, such as a multimodal neural network. The feature vectors may be generated from different types of input modes such as video, audio, text etc. Additionally, the feature vectors may be generated from a common source input mode but via different methods. For proper concatenation and representation during classification it is desirable to synchronize the feature vectors. There are two methods for synchronization according to aspects of the present disclosure. A first proposed method is referred to herein as Sentence level Feature fusion. The second proposed method is referred to herein as Word level Feature Fusion. It should be understood that these two synchronization methods are not exclusive and the multimodal processing system may choose the synchronization method to use before processing or switch between synchronization methods during processing.

Sentence Level Feature Fusion

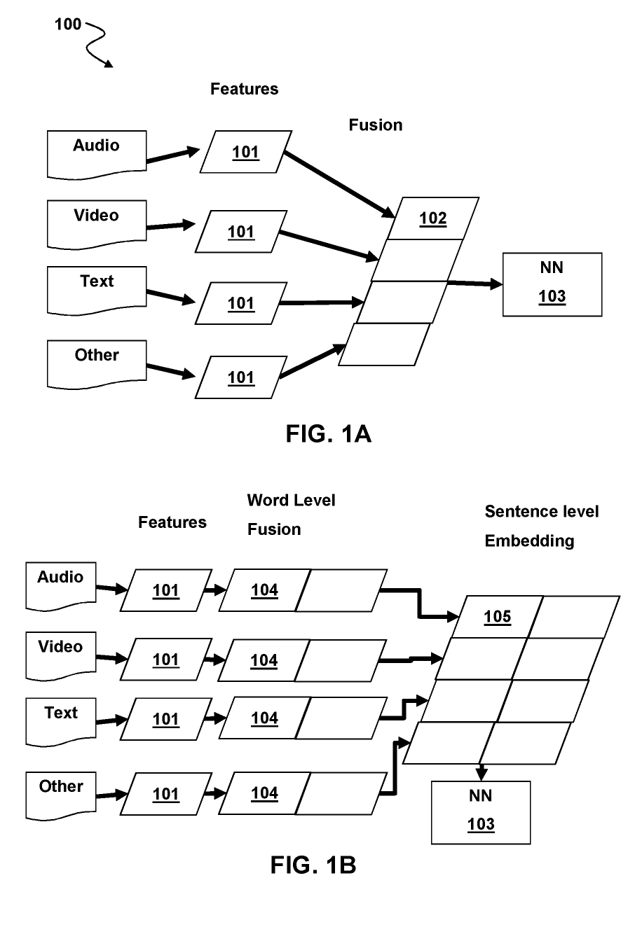

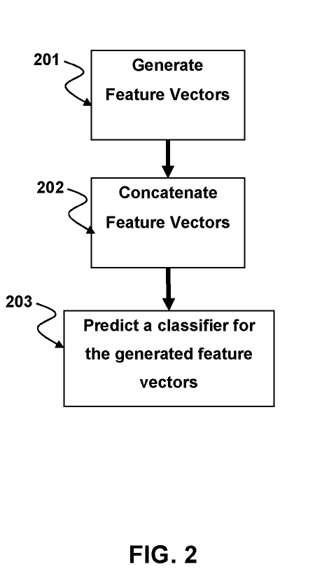

As seen in FIG. 1A and FIG. 2 Sentence Level Feature Fusion according to aspects of the present disclosure takes multiple different feature vectors 101 generated on a per sentence basis 201 and concatenates 202 them into a single vector 102 before performing classification 203 with a multimodal Neural Network 103. That is, each feature vector 101 of the multiple different types of feature vectors is generated on a per sentence level. After generation, the feature vectors are concatenated to create a single feature vector 103 herein referred to as a fusion vector. This fusion vector is then provided to a multimodal neural network configured to classify the features.

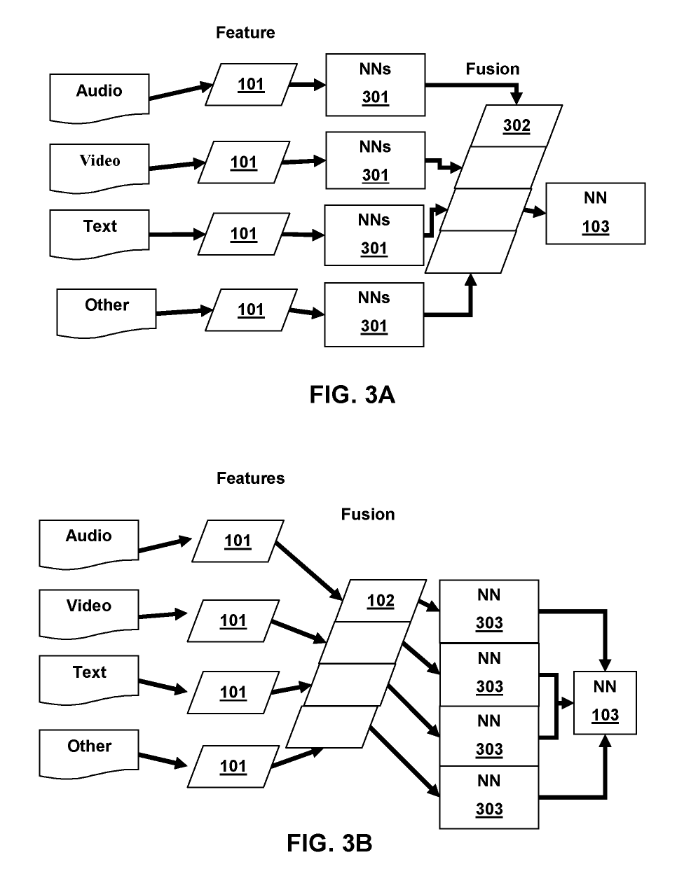

FIG. 3A and FIG. 3B illustrate examples of enhanced sentence length feature fusion according to additional aspects of the present disclosure. The classification of the sentence level fusion vector may be enhanced by the operation of one or more other neural networks 301 before concatenation and classification, as depicted in FIG. 3A. By way of example and not by way of limitation the one or more other neural networks 301 that operate before concatenation may be configured to map feature vectors to an emotional subspace vector and/or configured to identify attention features from the feature vectors. The network configured to map feature vectors to an emotional subspace vector may be any type known in the art but are preferably of the recurrent type, such as, plain RNN, long-short term memory, etc. The neural network configured to identify attention areas may be any type suited for the task. According to other alternative aspects of the present disclosure a second set of unimodal neural networks 303 may be provided after concatenation and before multimodal classification, as shown in FIG. 3B. This set of unimodal neural networks may be configured to optimize the fusion of features in the fusion vector and improve classification by the multimodal neural network 103. The unimodal neural networks may be of the deep learning type, without limitation. Such deep learning neural networks may comprise one or more convolutional neural network layers, pooling layers, max pooling layer, ReLu layers etc.

Word Level Feature Fusion

FIG. 1B depicts word level feature fusion according to aspects of the present disclosure. Word level feature fusion takes multiple different feature vectors 101 generated on a per word level and concatenates them together to generate a single word level fusion vector 104 word level fusion vectors are fused to generate sentence level embeddings 105 before classification 103. Although described as word level feature fusion, aspects of the present disclosure are not limited to word-level synchronization. In some alternative implementations, synchronization and classification may be done on a sub-sentence level such as, without limitation, the level of phonemes or visemes. Visemes are similar to phonemes but the visual facial representation of the pronunciation of a speech sound. While phonemes and visemes are related, there is not a one-to-one relationship between them, as there may be several phonemes that correspond to a given single viseme. Viseme-level vectors may allow language independent emotion detection. An advantage of word level fusion is that a finer granularity of classification is possible because each word may be classified separately, thus fine-grained classification of changes in emotion and other qualifiers mid-sentence are possible. This is useful for real time emotion detection and low latency emotion detection when sentences are long.

According to additional aspects of the present disclosure, classification of word level (or viseme level) fusion vectors may be enhanced by the provision of one or more additional neural networks before the multimodal classifier neural network. As is generally understood by those skilled in the art of speech recognition, a visemes are basic visual building blocks of speech. Each language has a set of visemes that correspond to their specific phonemes. In a language, each phoneme has a corresponding viseme that represents the shape that the mouth makes when forming the sound. It should be noted that phonemes and visemes do not necessarily share a one-to-one correspondence. Some visemes may correspond to multiple phonemes and vice versa. Aspects of the present disclosure include implementations in which classifying input information is enhanced through viseme-level feature fusion. Specifically, video feature information can be extracted from a video stream and other feature information (e.g., audio, text, etc.) can be extracted from one or more other inputs associated with the video stream. By way of example, and not by way of limitation, the video stream may show the face of a person speaking and the other information may include a corresponding audio stream of the person speaking. One set of viseme-level feature vectors is generated from the video feature information and a second set of viseme-level feature vectors from the other feature information. The first and second sets of viseme-level feature vectors are fused to generate fused viseme-level feature vectors, which are sent to a multimodal neural network for classification.

The additional neural networks may comprise a dynamic recurrent neural network configured to improve embedding of word-level and/or viseme-level fused vectors and/or a neural network configured to identify attention areas to improve classification in important regions of the fusion vector. In some implementations, viseme-level feature fusion can also be used for language-independent emotion detection.

As used herein the neural network configured to identify attention areas (attention network) may be trained to synchronize information between different modalities of the fusion. For example and without limitation, an attention mechanism may be used to determine which parts of a temporal sequence are more important or to determine which modality (e.g., audio, video or text) is more important and give higher weights to the more important modality or modalities. The system may correlate audio and video information by vector operations, such as concatenation or element-wise product of audio and video features to create a reorganized fusion vector.

Decision Fusion

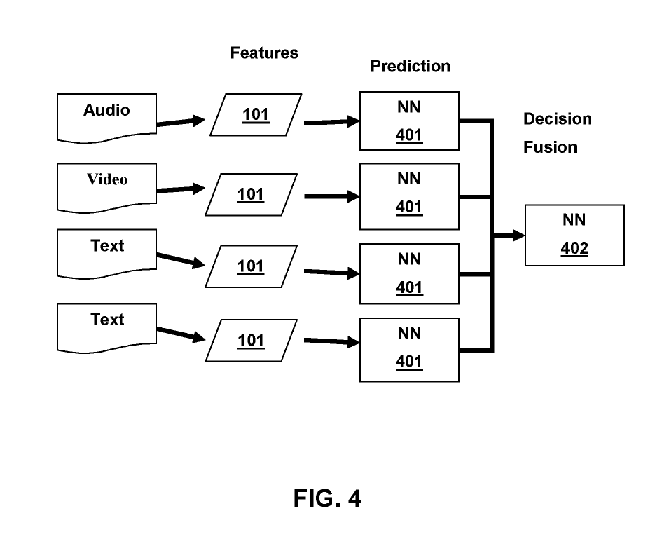

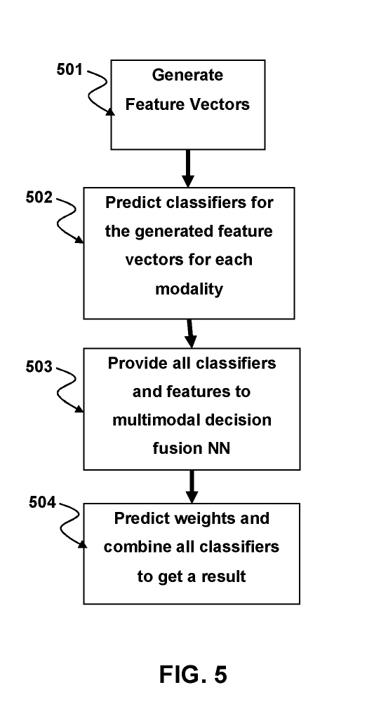

FIG. 4 and FIG. 5 respectively depict a system and method for decision fusion according to aspects of the present disclosure. Decision Fusion fuses classifications from unimodal neural networks 401 of feature vectors 101 for different input modes and uses the fused classification for a final multimodal classification 402. Decision fusion generates a classification for each type of input feature and combines the classifications. The combined classifications are used for a final classification. The unimodal neural networks may receive as input raw unmodified features or feature vectors generated by the system 501. The unmodified features or feature vectors are then classified by a unimodal neural network 502. These predicted classifiers are then concatenated for each input type and provided to the multimodal neural network 503. The multimodal neural network then provides the final classification based on the concatenated classifications from the previous unimodal neural networks 504. In some embodiments the multimodal neural network may also receive the raw unmodified features or feature vectors.

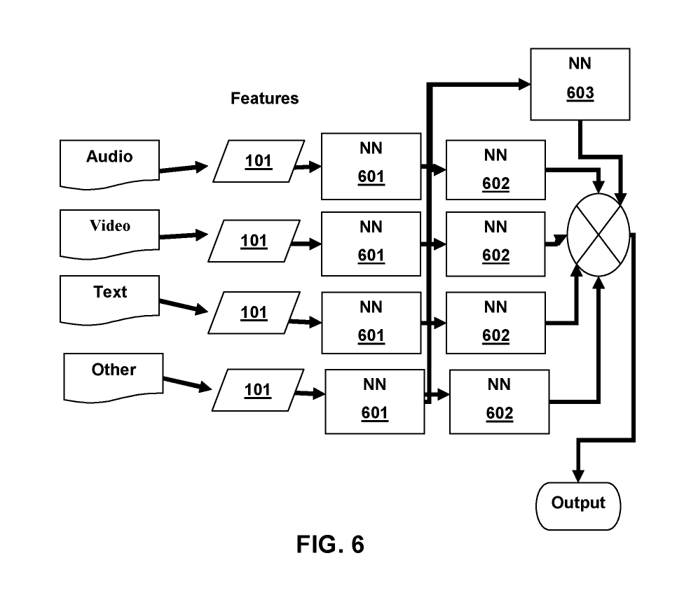

According to aspects of the present disclosure each type of input sequence of feature vectors representing each sentence for each modality may have additional feature vectors embedded by a classifier specific neural network as depicted in FIG. 6. By way of example and not by way of limitation the classifier specific 601 neural network may be an emotion specific embedding neural network, a personality specific embedding neural network, intention specific embedding neural network, internal state specific embedding neural network, mood specific embedding neural network, etc. It should be noted that not all modalities need use the same type of classifier specific neural network and the type of neural network may be chosen to fit the modality. The results of the embedding for each type of input may then be provided to a separate neural network for classification 602 based on the classification specific embeddings to obtain sentence level embeddings. Additionally according to aspects of the present disclosures the combined features with classification specific embeddings may be provided to a weighting neural network 603 to predict the best weights to apply to each classification. In other word the weighting neural network uses features to predict which modality receives more or less importance. The weights are then applied based on the predictions made by the weighting neural network 603. The final decision is determined by taking a weighted sum of the individual decisions where the weights are positive and always add to 1.

Rule-Based Audio Features

Rule-based audio features according to aspects of the present disclosure extracts feature information from speech using the fundamental frequency. It has been found that the fundamental frequency of the speech can be correlated to different internal states of the speaker and thus can be used to determine information about user characteristics. By way of example and not by way of limitation, information that may be determined from the fundamental frequency (f₀) of speech includes; the emotional state of the speaker, the intention of the speaker, the mood of the speaker, etc.

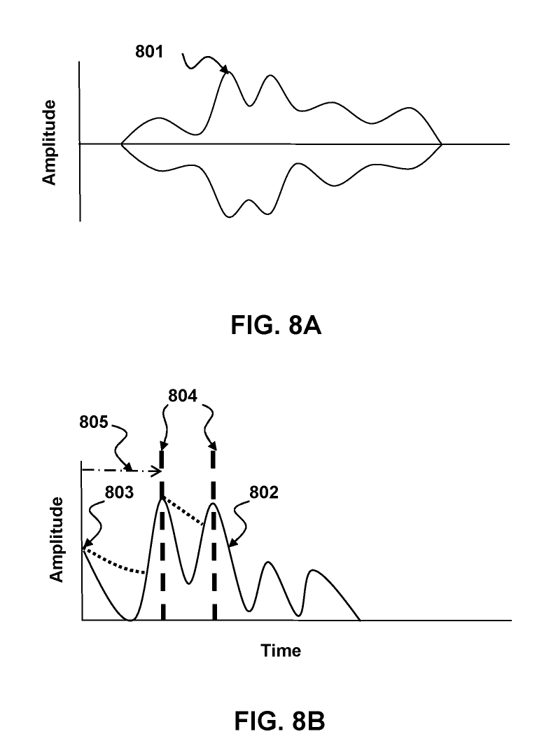

As seen in FIG. 8A the system may apply a transform to the speech signal 801 to create a plurality of waves representing the component waves of the speech signal. The transform may be any type known in the art by way of example and not by way of limitation the transform may be, Fourier transform, a fast Fourier transform, cosine transform etc. According to other aspects of the present disclosure the system may determine F0 algorithmically. In an embodiment, the system estimates the fundamental frequency using the correlation of two related functions to determine an intersection of those two functions which corresponds to a maxima within a moving frame of the raw audio signal as seen in FIG. 8B. The First function 802 is a signal function Zₖ which is calculated by the equation:

Zₖ=Σₘ₌₁^{M}^{ₛ}sₘxₘ+k (eq. 1)

Where xₘ is the sampled signal, sₘ is the moving frame segment 804, m is sample point and k corresponds to the shift in the moving frame segment along the sampled signal. The number of sample points in the moving frame segment (Mₛ) 804 is determined by the equation Mₛ=ƒₛ/Fₗ where Fₗ is the lowest frequency that can be resolved. Thus length of the moving frame segment (Tₛ) is resolved by Tₛ=Mₛ/ƒₛ. The second function 803 is a peak detection function yₖ provided by the equation;

$${y}_{k} = {z}_{{k}_{0}}^{- \frac{k - {k}_{0}}{{f}_{s} τ}} \qquad ( eq . 2 )$$

Where τ is an empirically determined time constant that depends on the length of the moving frame segment and the range of frequencies generally without limitation between 6-10 ms is suitable.

The result of these two equations is that peak detection function intersects with the signal function and resets to the maximum value of the signal function at the intersection. The peak function then continues decreasing until it intersects with the signal function again and the process repeats. The result of the peak detection function yₖ is the period 805 of the audio (N_{period}) in samples. The fundamental frequency is thus F0=ƒₛ/N_{period}. More information about this F0 estimation system can be found in Staudacher et al. “Fast fundamental frequency determination via adaptive autocorrelation,” EURASIP Journal of Audio, Speech and Music Processing, 2016:17, Oct. 24, 2016.

It should be noted that while one specific F0 estimation system was described above any suitable F0 estimation technique may be used herein. Such alternative estimation techniques include without limitation, Frequency domain-based subharmonic-to-harmonic ratio procedures, Yin Algorithms and other autocorrelation algorithms.

According to aspects of the present disclosure the fundamental frequency data may be modified for multimodal processing using average of fundamental frequency (F0) estimations and a voicing probability. By way of example and not by way of limitation F0 may be estimated every 10 ms and averaging. Every 25 consecutive estimates that contain a real F0 may be averaged. Each F0 estimate is checked to determine whether contains a voice. Each F0 estimate value is checked to determine if the estimate is greater than 40 Hz. If the F0 estimate is greater than 40 Hz then the frame is considered voiced and as such the audio contains a real F0 and is included in the average. If the audio signal in the sample is lower than 40 Hz, that F0 sample is not included in the average and the frame is considered unvoiced. The voicing probability is estimated as followed: (Number voiced frames)/(Number voiced+Number of unvoiced frames over a signal segment). The F0 averages and the voicing probabilities are estimated every 250 ms or every 25 frames. The speech or signal segment is 250 ms and it includes 25 frames. According to some embodiments the system estimated 4 F0 average values and 4 voicing probabilities every second. The four average values and 4 voicing probabilities may then be used are as feature vectors for multimodal classification of user characteristics. It should be note that the system may generate any number of average values and voice probabilities for use with the multimodal neural network and the system is not limited to 4 values as disclosed above.

Auditory Attention Features

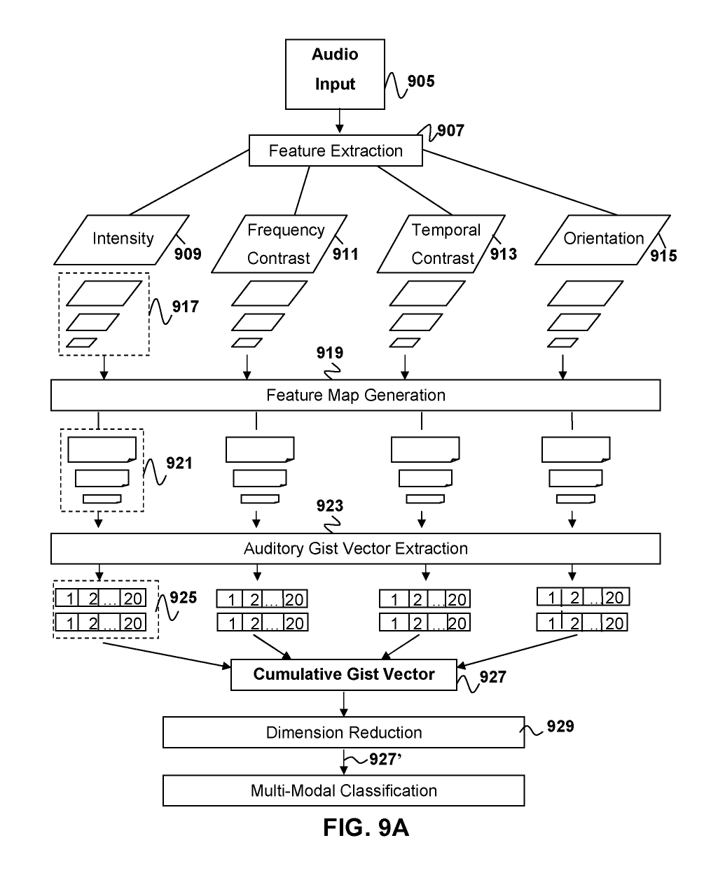

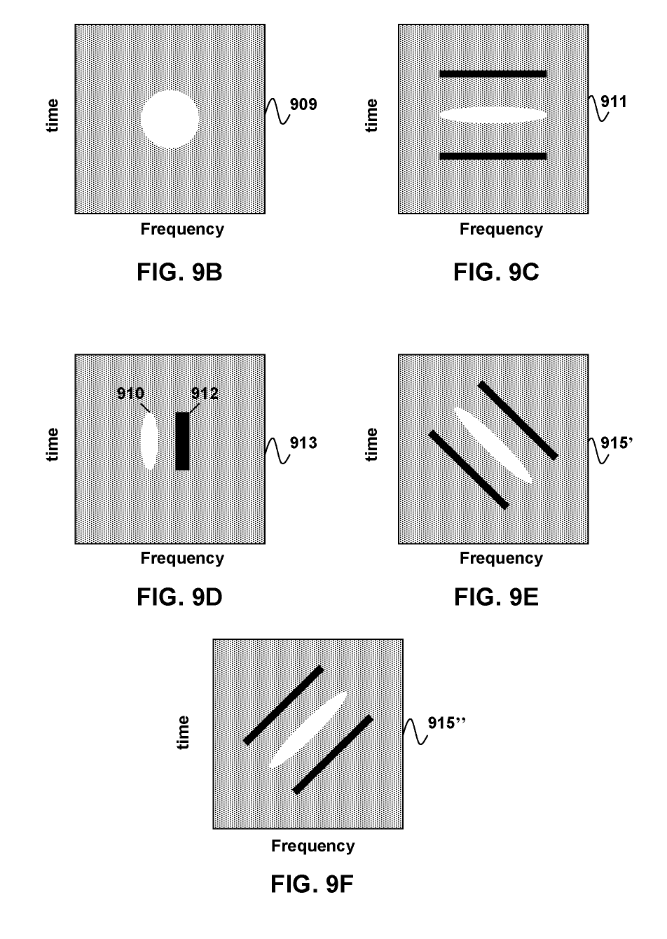

In addition to extracting fundamental frequency information corresponding to rule audio features the multimodal processing systems according to aspects of the present disclosure may extract audio attention features from inputs. FIG. 9A depicts a method for generation of audio attention features from an audio input 905. The audio input without limitation may be a pre-processed audio spectrum or a recoded window of audio that has undergone processing before audio attention feature generation. Such pre-processing may mimic the processing that sound undergoes in the human ear. Additionally low level feature may be processed using other filtering software such as, without limitation, filterbank, to further improve performance. Auditory attention can be captured by or voluntarily directed to a wide variety of acoustical features such as intensity (or energy), frequency, temporal, pitch, timbre, FM direction or slope (called “orientation” here), etc. These features can be selected and implemented to mimic the receptive fields in the primary auditory cortex.

By way of example, and not by way of limitation, four features that can be included in the model to encompass the aforementioned features are intensity (I), frequency contrast (F), temporal contrast (T), and orientation (O_{θ}) with θ={45°, 135°}. The intensity feature captures signal characteristics related to the intensity or energy of the signal. The frequency contrast feature captures signal characteristics related to spectral (frequency) changes of the signal. The temporal contrast feature captures signal characteristics related to temporal changes in the signal. The orientation filters are sensitive to moving ripples in the signal.

Each feature may be extracted using two-dimensional spectro-temporal receptive filters 909, 911, 913, 915, which mimic the certain receptive fields in the primary auditory cortex. FIGS. 9B-9F respectively illustrate examples of the receptive filters (RF) 909, 911, 913, 915. Each of the receptive filters (RF) 909, 911, 913, 915 simulated for feature extraction is illustrated with gray scaled images corresponding to the feature being extracted. An excitation phase 910 and inhibition phase 912 are shown with white and black color, respectively.

Each of these filters 909, 911, 913, 915 is capable of detecting and capturing certain changes in signal characteristics. For example, the intensity filter 909 illustrated in FIG. 9B may be configured to mimic the receptive fields in the auditory cortex with only an excitatory phase selective for a particular region, so that it detects and captures changes in intensity/energy over the duration of the input window of sound. Similarly, the frequency contrast filter 911 depicted in FIG. 9C may be configured to correspond to receptive fields in the primary auditory cortex with an excitatory phase and simultaneous symmetric inhibitory sidebands. The temporal contrast filter 913 illustrated in FIG. 9D may be configured to correspond to the receptive fields with an inhibitory phase and a subsequent excitatory phase.

The frequency contrast filter 911 shown in FIG. 9C detects and captures spectral changes over the duration of the sound window. The temporal contrast filter 913 shown in FIG. 9D detects and captures changes in the temporal domain. The orientation filters 915′ and 915″ mimic the dynamics of the auditory neuron responses to moving ripples. The orientation filter 915′ can be configured with excitation and inhibition phases having 45° orientation as shown in FIG. 9E to detect and capture when ripple is moving upwards. Similarly, the orientation filter 915″ can be configured with excitation and inhibition phases having 135° orientation as shown in FIG. 9F to detect and capture when ripple is moving downwards. Hence, these filters also capture when pitch is rising or falling.

The RF for generating frequency contrast 911, temporal contrast 913 and orientation features 915 can be implemented using two-dimensional Gabor filters with varying angles. The filters used for frequency and temporal contrast features can be interpreted as horizontal and vertical orientation filters, respectively, and can be implemented with two-dimensional Gabor filters with 0° and 90°, orientations. Similarly, the orientation features can be extracted using two-dimensional Gabor filters with {45°, 135°} orientations. The RF for generating the intensity feature 909 is implemented using a two-dimensional Gaussian kernel.

The feature extraction 907 is completed using a multi-scale platform. The multi-scale features 917 may be obtained using a dyadic pyramid (i.e., the input spectrum is filtered and decimated by a factor of two, and this is repeated). As a result, eight scales are created (if the window duration is larger than 1.28 seconds, otherwise there are fewer scales), yielding size reduction factors ranging from 1:1 (scale 1) to 1:128 (scale 8). In contrast with prior art tone recognition techniques, the feature extraction 907 need not extract prosodic features from the input window of sound 901. After multi-scale features 917 are obtained, feature maps 921 are generated as indicated at 919 using those multi-scale features 917. This is accomplished by computing “center-surround” differences, which involves comparing “center” (fine) scales with “surround” (coarser) scales. The center-surround operation mimics the properties of local cortical inhibition and detects the local temporal and spatial discontinuities. It is simulated by across scale subtraction (θ) between a “center” fine scale (c) and a “surround” coarser scale (s), yielding a feature map M(c, s): M(c, s)=|M(c)θM(s)|, M∈{I, F, T, O_{θ}}. The across scale subtraction between two scales is computed by interpolation to the finer scale and point-wise subtraction

Next, an “auditory gist” vector 925 is extracted as indicated at 923 from each feature map 921 of I, F, T, O_{θ}, such that the sum of auditory gist vectors 925 covers the entire input sound window 901 at low resolution. To determine the auditory gist vector 925 for a given feature map 921, the feature map 921 is first divided into an m-by-n grid of sub-regions, and statistics, such as maximum, minimum, mean, standard deviation etc., of each sub-region can be computed.

After extracting an auditory gist vector 925 from each feature map 921, the auditory gist vectors are augmented and combined to create a cumulative gist vector 927. The cumulative gist vector 927 may additionally undergo a dimension reduction 129 technique to reduce dimension and redundancy in order to make tone recognition more practical. By way of example and not by way of limitation, principal component analysis (PCA) can be used for the dimension reduction 929. The result of the dimension reduction 929 is a reduced cumulative gist vector 927′ that conveys the information in the cumulative gist vector 927 in fewer dimensions. PCA is commonly used as a primary technique in pattern recognition. Alternatively, other linear and nonlinear dimension reduction techniques, such as factor analysis, kernel PCA, linear discriminant analysis (LDA) and the like, may be used to implement the dimension reduction 929.

Finally, after the reduced cumulative gist vector 927′ that characterizes the input audio 901 has been determined, classification by a multimodal neural network may be performed. More information on the computation of Auditory Attention features is described in commonly owned U.S. Pat. No. 8,676,574 the content of which are incorporated herein by reference.

Automatic Speech Recognition

According aspects of the present disclosure automatic speech recognition may be performed on the input audio to extract a text version of the audio input. Automatic Speech Recognition may identify known words from phonemes. More information about Speech Recognition can be found in Lawerence Rabiner, “A Tutorial on Hidden Markov Models and Selected Application in Speech Recognition” in Proceeding of the IEEE, Vol. 77, No. 2, February 1989 which is incorporated herein by reference in its entirety for all purposes. The raw dictionary selection may be provided to the multimodal neural network.

Linguistic Feature Analysis

Linguistic feature analysis according to aspects of the present disclosure uses text input generated from either automatic speech recognition or directly from a text input such as an image caption and generates feature vectors for the text. The resulting feature vector may be language dependent, as in the case of word embedding and part of speech, or language independent, as in the case of sentiment score and word count or duration. In some embodiments these word embeddings may be generated by such systems a SentiWordNet in combination with other text analysis systems known in the art. These multiple textual features are combined to form a feature vector that is input to the multimodal neural network for emotion classification.

Rule-Based Video Features

Rule-based Video Feature extraction according to aspects of the present disclosure looks at facial features, heartbeat, etc. to generate feature vectors describing user characteristics within the image. This involves finding a face in the image (Open-CV or proprietary software/algorithm), tracking the face, detecting facial parts, e.g., eyes, mouth, nose (Open-CV or proprietary software/algorithm), detecting head rotation and performing further analysis. In particular, the system may calculate Eye Open Index (EOI) from pixels corresponding to the eyes and detect when the user blinks from sequential EOIs. Heartbeat detection involves calculating a skin brightness index (SBI) from face pixels, detecting a pulse-waveform from sequential SBIs and calculating a pulse-rate from the waveform.

Neural Video Features

According to aspects of the present disclosure Deep Learning Video Feature uses generic image vectors for emotion recognition and extracts neural embeddings for raw video frames and facial image frames using deep convolutional neural networks (CNN) or other deep learning neural networks. The system can leverage generic object recognition and face recognition models trained on large datasets to embed video frames by transfer learning and use these as feature embeddings for emotion analysis. It might be implicitly learning all the eye or mouth related features. The Deep learning video features may generate vectors representing small changes in the images which may correspond to changes in emotion of the subject of the image. The Deep learning video feature generation system may be trained using unsupervised learning. By way of example and not by way of limitation the Deep learning video feature generation system may be trained as an auto-encoder and decoder model. The visual embeddings generated by the encoder may be used as visual features for emotion detection using a neural network. Without limitation more information about Deep learning video feature system can be found in the concurrently filed application No. 62/959,639 (Attorney Docket: SCEA17116US00) which is incorporated herein by reference in its entirety for all purposes.

Additional Features

According to alternative aspects of the present disclosure, other feature vectors may be extracted from the other inputs for use by the multimodal neural network. By way of example and not by way of limitation these other features may include tactile or haptic input such as pressure sensors on a controller or mounted in a chair, electromagnetic input, biological features such as heart beat, blink rate, smiling rate, crying rate, galvanic skin response, respiratory rate, etc. These alternative features vectors may be generated from analysis of their corresponding raw input. Such analysis may be performed by a neural network trained to generate a feature vector from the raw input. Such additional feature vectors may then be provided to the multimodal neural network for classification.

Neural Network Training

The multimodal processing system for integrated understanding of user characteristics according to aspects of the present disclosure comprises many neural networks. Each neural network may serve a different purpose within the system and may have a different form that is suited for that purpose. As disclosed above neural networks may be used in the generation of feature vectors. The multimodal neural network itself may comprise several different types of neural networks and may have many different layers. By way of example and not by way of limitation the multimodal neural network may consist of multiple convolutional neural networks, recurrent neural networks and/or dynamic neural networks.

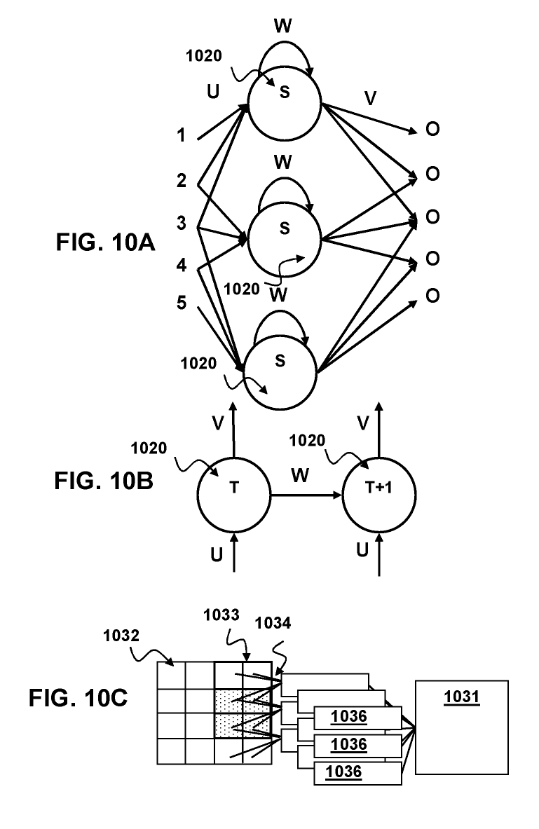

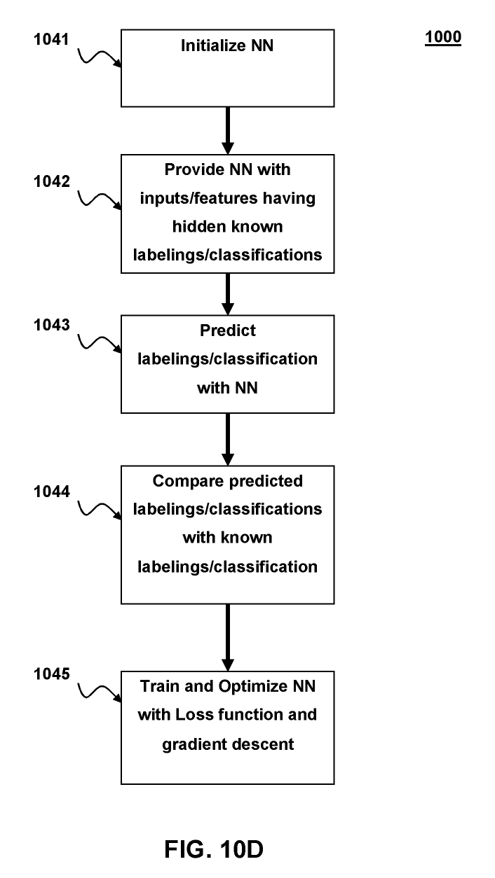

FIG. 10A depicts the basic form of an RNN having a layer of nodes 1020, each of which is characterized by an activation function S, one input weight U, a recurrent hidden node transition weight W, and an output transition weight V. It should be noted that the activation function S may be any non-linear function known in the art and is not limited to the (hyperbolic tangent (tan h) function. For example, the activation function S may be a Sigmoid or ReLu function. Unlike other types of neural networks RNNs have one set of activation functions and weights for the entire layer. As shown in FIG. 10B the RNN may be considered as a series of nodes 1020 having the same activation function moving through time T and T+1. Thus the RNN maintains historical information by feeding the result from a previous time T to a current time T+1.

In some embodiments a convolutional RNN may be used. Another type of RNN that may be used is a Long Short-Term Memory (LSTM) Neural Network which adds a memory block in a RNN node with input gate activation function, output gate activation function and forget gate activation function resulting in a gating memory that allows the network to retain some information for a longer period of time as described by Hochreiter & Schmidhuber “Long Short-term memory” Neural Computation 9(8):1735-1780 (1997)

FIG. 10C depicts an example layout of a convolution neural network such as a CRNN according to aspects of the present disclosure. In this depiction the convolution neural network is generated for an image 1032 with a size of 4 units in height and 4 units in width giving a total area of 16 units. The depicted convolutional neural network has a filter 1033 size of 2 units in height and 2 units in width with a skip value of 1 and a channel 1036 size of 9. (For clarity in depiction only the connections 1034 between the first column of channels and their filter windows is depicted.) The convolutional neural network according to aspects of the present disclosure may have any number of additional neural network node layers 1031 and may include such layer types as additional convolutional layers, fully connected layers, pooling layers, max pooling layers, local contrast normalization layers, etc. of any size.

As seen in FIG. 10D Training a neural network (NN) begins with initialization of the weights of the NN 1041. In general the initial weights should be distributed randomly. For example an NN with a tan h activation function should have random values distributed between

$$- \frac{1}{\sqrt{n}} and \frac{1}{\sqrt{n}}$$

where n is the number of inputs to the node.

After initialization the activation function and optimizer is defined. The NN is then provided with a feature or input dataset 1042. Each of the different features vectors that are generated with a unimodal NN may be provided with inputs that have known labels. Similarly the multimodal NN may be provided with feature vectors that correspond to inputs having known labeling or classification. The NN then predicts a label or classification for the feature or input 1043. The predicted label or class is compared to the known label or class (also known as ground truth) and a loss function measures the total error between the predictions and ground truth over all the training samples 1044. By way of example and not by way of limitation the loss function may be a cross entropy loss function, quadratic cost, triplet contrastive function, exponential cost, etc. Multiple different loss functions may be used depending on the purpose. By way of example and not by way of limitation, for training classifiers a cross entropy loss function may be used whereas for learning pre-trained embedding a triplet contrastive function may be employed. The NN is then optimized and trained, using the result of the loss function and using known methods of training for neural networks such as backpropagation with adaptive gradient descent etc. 1045. In each training epoch, the optimizer tries to choose the model parameters (i.e. weights) that minimize the training loss function (i.e. total error). Data is partitioned into training, validation, and test samples.

During training the Optimizer minimizes the loss function on the training samples. After each training epoch, the mode is evaluated on the validation sample be computing the validation loss and accuracy. If there is no significant change, training can be stopped. Then this trained model may be used to predict the labels of the test data.

Thus the multimodal neural network may be trained to from different modalities of training data having known user characteristics. The multimodal neural network may be trained alone with labeled feature vectors having known user characteristics or may be trained end to end with unimodal neural networks.

Implementation

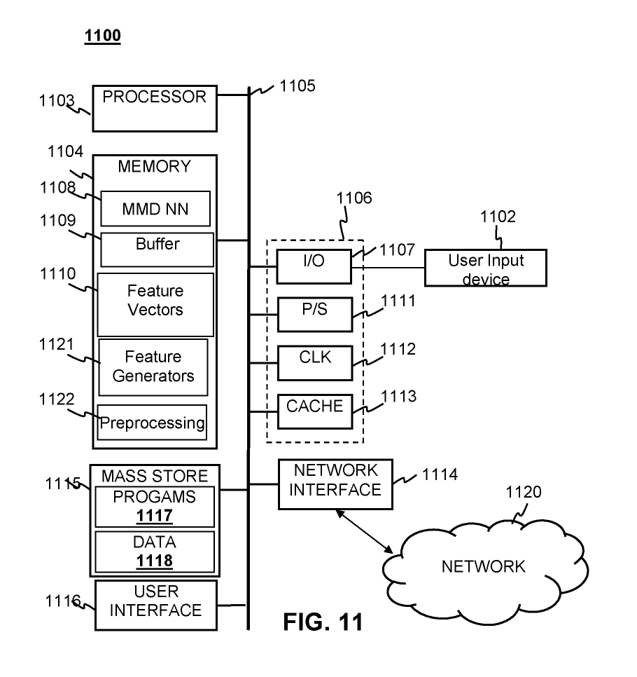

FIG. 11 depicts a system according to aspects of the present disclosure. The system may include a computing device 1100 coupled to a user input device 1102. The user input device 1102 may be a controller, touch screen, microphone or other device that allows the user to input speech data in to the system.

The computing device 1100 may include one or more processor units and/or one or more graphical processing units (GPU) 1103, which may be configured according to well-known architectures, such as, e.g., single-core, dual-core, quad-core, multi-core, processor-coprocessor, cell processor, and the like. The computing device may also include one or more memory units 1104 (e.g., random access memory (RAM), dynamic random access memory (DRAM), read-only memory (ROM), and the like).

The processor unit 1103 may execute one or more programs, portions of which may be stored in the memory 1104 and the processor 1103 may be operatively coupled to the memory, e.g., by accessing the memory via a data bus 1105. The programs may be configured to implement training of a multimodal NN 1108. Additionally, the Memory 1104 may contain programs that implement training of a NN configured to generate feature vectors 1121. The memory 1104 may also contain software modules such as a multimodal neural network module 608, an input stream pre-processing module 1122 and a feature vector generation Module 1121. The overall structure and probabilities of the NNs may also be stored as data 1118 in the Mass Store 1115. The processor unit 1103 is further configured to execute one or more programs 1117 stored in the mass store 1115 or in memory 1104 which cause processor to carry out the method 1000 for training a NN from feature vectors 1110 and/or input data. The system may generate Neural Networks as part of the NN training process. These Neural Networks may be stored in memory 1104 as part of the Multimodal NN Module 1108, Pre-Processing Module 1122 or the Feature Generator Module 1121. Completed NNs may be stored in memory 1104 or as data 1118 in the mass store 1115. The programs 1117 (or portions thereof) may also be configured, e.g., by appropriate programming, to decode encoded video and/or audio, or encode, un-encoded video and/or audio or manipulate one or more images in an image stream stored in the buffer 1109

The computing device 1100 may also include well-known support circuits, such as input/output (I/O) 1107, circuits, power supplies (P/S) 1111, a clock (CLK) 1112, and cache 1113, which may communicate with other components of the system, e.g., via the bus 1105. The computing device may include a network interface 1114. The processor unit 1103 and network interface 1114 may be configured to implement a local area network (LAN) or personal area network (PAN), via a suitable network protocol, e.g., Bluetooth, for a PAN. The computing device may optionally include a mass storage device 1115 such as a disk drive, CD-ROM drive, tape drive, flash memory, or the like, and the mass storage device may store programs and/or data. The computing device may also include a user interface 1116 to facilitate interaction between the system and a user. The user interface may include a keyboard, mouse, light pen, game control pad, touch interface, or other device.

The computing device 1100 may include a network interface 1114 to facilitate communication via an electronic communications network 1120. The network interface 1114 may be configured to implement wired or wireless communication over local area networks and wide area networks such as the Internet. The device 1100 may send and receive data and/or requests for files via one or more message packets over the network 1120. Message packets sent over the network 1120 may temporarily be stored in a buffer 1109 in memory 1104.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method for multimodal classification, comprising the steps of:
a) extracting fundamental frequency information from an audio input;
b) extracting other feature information from one or more other inputs;
c) classifying the fundamental frequency information and the other feature information using a multimodal neural network.

2. The method of claim 1 wherein the other feature information includes a video feature vector extracted generated by a neural network.

3. The method of claim 1 wherein extracting the other feature information includes facial parts and locations tracking, or blink detection, or pulse rate detection.

4. The method of claim 3 wherein the other feature information includes facial parts location, or blink occurrence, or pulse rate information.

5. The method of claim 1 wherein the other feature information includes auditory attention features.

6. The method of claim 1 wherein the other feature information includes text.

7. The method of claim 1 further comprising generating a text representation of the audio input and wherein d) further comprises classifying the text representation of the audio.

8. The method of claim 7 wherein classifying the text representation of the audio comprises using a neural network to classify an intent from the text representation.

9. The method of claim 7 wherein classifying the text representation of the audio comprises extracting a part of speech vector and/or sentiment lexical feature vector.

10. The method of claim 1 wherein the fundamental frequency information and the other feature information is classified for each word or viseme.

11. The method of claim 10 wherein the fundamental frequency information and the other feature information is fused to generate a single fusion vector before classification in step d).

12. The method of claim 11 further comprising generating sentence level embeddings and identifying attention features before generating a single fusion vector and classifying the fundamental frequency information and the other feature information using a multimodal neural network.

13. The method of claim 1 wherein the fundamental frequency information and the other feature information is classified for each sentence.

14. The method of claim 13 wherein the fundamental frequency information and the other feature information is classified with a neural network and wherein the classification of the fundamental frequency information and the other feature information is further classified in step d).

15. The method of claim 14 wherein the multimodal neural network of c) is a weighting neural network.

16. The method of claim 13 wherein the fundamental frequency information and the other feature information is fused to generate a single fusion vector before classification in c)

17. The method of claim 16 wherein the fundamental frequency information and the other feature information are mapped to a new representation space and attention features are identified using one or more neural networks before concatenation.

18. The method of claim 1 wherein the multimodal neural network in c) is configured to classify an emotional state or mood from the audio and other input.

19. The method of claim 1 wherein the multimodal neural network in c) is configured to classify an intention from the audio and other input.

20. The method of claim 1 wherein the multimodal neural network in c) is configured to classify an internal state of a person in the audio and other input.

21. The method of claim 1 wherein the multimodal neural network in c) is configured to classify a personality of a person in the audio and other input.

22. The method of claim 1 wherein the multimodal neural network in c) is configured to classify an identity of a person in the audio and other input.

23. The method of claim 1 wherein the multimodal neural network in c) is configured to classify a mood of a person in the audio and other input.

24. A system for multimodal classification, comprising:
a processor;
memory;
a computer readable medium with non-transitory instructions embodied thereon, the instruction causing the processor to perform a method for multimodal classification, the method comprising:
a) extracting fundamental frequency information from an audio input;
b) extracting other feature information from one or more other inputs;
c) classifying the fundamental frequency information and other feature information using the multimodal neural network.

25. The system of claim 24 wherein the other feature information is a video feature vector extracted generated by a neural network.

26. The system of claim 24 wherein extracting the other feature information comprises facial parts and locations tracking, or blink detection, or pulse rate detection.

27. The system of claim 26 wherein the other feature information comprises facial parts location, or blink occurrence, or pulse rate information.

28. The system of claim 24 wherein the other feature information is auditory attention features.

29. The system of claim 24 wherein the other feature information is text.

30. The system of claim 24 further comprising generating a text representation of the audio input and wherein d) further comprises classifying the text representation of the audio.

31. The system of claim 24 wherein classifying the text representation of the audio comprises using a neural network to classify an intent from the text representation.

32. The system of claim 24 wherein classifying the text representation of the audio comprises extracting a part of speech vector or sentiment lexical feature vector.

33. The system of claim 24 wherein the fundamental frequency information and the other feature information is classified for each word or viseme.

34. The system of claim 33 wherein the fundamental frequency information and the other feature information is fused to generate a single fusion vector before classifying the fundamental frequency information and other feature information using the multimodal neural network.

35. The system of claim 34 further comprising generating sentence level embeddings and identifying attention features in the fusion vector before classification in step d).

36. The system of claim 24 wherein the fundamental frequency information and the other feature information is classified for each sentence.

37. The system of claim 37 wherein the fundamental frequency information and the other feature information is classified with a neural network and wherein the classification of the fundament frequency information and the other feature information is further classified in c).

38. The system of claim 37 wherein the multimodal neural network of c) is a weighting neural network.

39. The system of claim 37 wherein the fundamental frequency information and the other feature information is fused to generate a single fusion vector before classification in step d)

40. The system of claim 39 wherein the fundamental frequency information and the other feature information are mapped to a new representation space and attention features are identified using one or more neural networks before concatenation.

41. The system of claim 24 wherein the multimodal neural network in c) is configured to classify an emotion from the audio and other input.

42. The system of claim 24 wherein the multimodal neural network in c) is configured to classify an intention from the audio and other input.

43. The system of claim 24 wherein the multimodal neural network in c) is configured to classify an internal state of a person in the audio and other input.

44. The system of claim 24 wherein the multimodal neural network in c) is configured to classify a personality of a person in the audio and other input.

45. The system of claim 24 wherein the multimodal neural network in c) is configured to classify an identity of a person in the audio and other input.

46. The system of claim 24 wherein the multimodal neural network in c) is configured to classify a mood of a person in the audio and other input.

47. A method for multimodal classification, comprising the steps of:
a) extracting video feature information from a video stream
b) extracting other feature information from one or more other inputs associated with the video stream;
c) generating a first set of viseme-level feature vectors from the video feature information and a second set of viseme-level feature vectors from the other feature information;
d) fusing the first and second sets of viseme-level feature vectors to generate fused viseme-level feature vectors;
e) classifying the audio feature information by applying a multimodal neural network to the fused viseme-level feature vectors.

48. A method for multimodal classification, comprising the steps of:
a) extracting audio feature information from an audio stream
b) extracting other feature information from one or more other inputs associated with the audio stream;
c) generating a first set of word-level feature vectors from the audio feature information and a second set of word-level feature vectors from the other feature information;
d) fusing the first and second sets of word-level feature vectors to generate fused word-level feature vectors;
e) classifying the audio feature information by applying a multimodal neural network to the fused word-level feature vectors.
